(19) United States
(12) Patent Application Publication
(10) Pub. No.: US 2026/0029573 A1
(43) Pub. Date: Jan. 29, 2026

(54) OPTICAL HOLLOW WAVEGUIDE ASSEMBLY, ILLUMINATION OPTICS UNIT AND INSPECTION APPARATUS

(71) Applicant: Carl Zeiss SMT GmbH, Oberkochen (DE)

(72) Inventors: Michael Lohmeier, Schwäbisch-Gmünd (DE); Karl Fenkl, Illertissen (DE); Eugen Anselm, Aalen (DE); Senol Temizkan, Aalen (DE); Fabian Teschner, München (DE)

(21) Appl. No.: 19/262,520

(22) Filed: Jul. 8, 2025

(30) Foreign Application Priority Data
Jul. 26, 2024 (DE) 102024207074.2

(51) Int. Cl. G02B 6/032; G01N 21/33

(52) U.S. Cl. CPC G02B 6/032; G01N 21/33; G01N 2201/08; G02B 2006/0325

(57) ABSTRACT

An optical hollow waveguide assembly comprises an optical hollow waveguide for guiding illumination light, having a main body having a continuous waveguide cavity having a waveguide input and a waveguide output, wherein a waveguide cavity inner wall of the waveguide cavity is designed to be highly reflective for the illumination light at least under grazing incidence. The hollow waveguide assembly furthermore comprises a waveguide purging device for purging the waveguide cavity with a purge gas, comprising a purge gas connector and at least one nozzle disposed fluidically downstream of the purge gas connector in order to supply the purge gas, at least indirectly, to the waveguide output, in order to generate a purge gas flow from the waveguide output to the waveguide input.

### CROSS-REFERENCE TO RELATED APPLICATION

This application claims priority to German patent application DE 10 2024 207 074.2, filed on Jul. 26, 2024, the entire content of which is incorporated by reference herein.

### TECHNICAL FIELD

The invention relates to an optical hollow waveguide assembly, to an illumination optics unit having such an optical hollow waveguide assembly, and to an inspection apparatus having such an illumination optics unit.

### BACKGROUND

A hollow waveguide assembly is already known from WO 2015/003 903 A1, for example.

### SUMMARY

One problem that can be addressed by the present invention is that of improving an optical hollow waveguide assembly, in particular providing an optical hollow waveguide assembly which has reliable purging and is optimized in particular with regard to the utilization of installation space in the illumination optics unit.

This problem can be solved by an optical hollow waveguide assembly having the features presented in Claim 1.

According to the invention, it has been recognized that generating the purge gas flow, in particular the continuous purge gas flow, from the waveguide output to the waveguide input makes it possible to provide an optical hollow waveguide assembly which is of particularly compact design. An arrangement of further components of the hollow waveguide assembly and/or of an optical system comprising the hollow waveguide assembly is scarcely, in particular not, adversely affected.

Further purge gas connectors at the main body, via which purge gas is supplied to the waveguide cavity, are omitted as a result of generating the purge gas flow from the waveguide output to the waveguide input. The main body of the hollow waveguide is able to be manufactured particularly simply as a result.

Moreover, further openings of the waveguide cavity, through which illumination light might escape and/or additional contaminants might pass into the waveguide cavity, are omitted. The waveguide cavity, in particular its wall surfaces and/or a coating of the wall surfaces, can be manufactured particularly precisely.

At the same time, it has been found that one-way purging of the waveguide cavity, from the waveguide output to the waveguide input, is sufficient for reliably cleaning the waveguide cavity and thereby protecting it from contaminations.

The contaminations may pass through the waveguide output and/or the waveguide input from other components of the illumination optics unit into the waveguide cavity, for example from an extreme ultraviolet (EUV) source, and thereby contaminate the waveguide cavity.

These contaminations can be eliminated by the purging by use of a purge gas, in particular by the continuous purging. In particular, hydrogen gas may be used as purge gas in this case.

It is possible in particular to purge, in particular to continuously purge, the waveguide cavity during the operation of a superordinate inspection apparatus. The hydrogen gas can then interact with the illumination light supplied to the waveguide cavity, in particular the deep ultraviolet (DUV) light or the EUV light, whereby free charge carriers arise which remove the contaminations.

The waveguide cavity is purged by the purge gas against the flow. This should be understood to mean that a direction of propagation of the illumination light, in particular of a chief ray of the illumination light, is oriented counter, in particular antiparallel, to a flow direction of the purge gas. An antiparallel orientation of two directions should be understood to mean that a scalar product of a normalized direction vector of the first direction and a normalized direction vector of the second direction is equal to minus one.

The hollow waveguide may be designed in particular to homogenize the illumination light. Since the inspection, for example of a photolithographic mask and/or a photolithographic wafer, may take place particularly accurately if the illumination light is as homogeneous as possible, the integrity of the hollow waveguide is of great importance for the field of mask inspection. The maintenance of this integrity is possible, in conjunction with optimum utilization of the installation space available, with a hollow waveguide assembly according to the invention.

The hollow waveguide, in particular the waveguide cavity, may extend in particular linearly, preferably along a central longitudinal axis of the hollow waveguide, in particular of the waveguide cavity. The central longitudinal axis of the hollow waveguide may be in particular parallel to an optical axis of a superordinate illumination optics unit.

The hollow waveguide, in particular the waveguide cavity, may have a length in the range of between 10 mm and 500 mm, for example in the range of between 20 mm and 500 mm, between 20 mm and 300 mm, or else between 20 mm and 80 mm. The length may be in particular a distance between the waveguide input and the waveguide output in the direction of the central longitudinal axis.

A ratio of the length of the waveguide cavity to the diameter thereof perpendicular to the central longitudinal axis may be in particular in the range of between 10 and 1000, for example between 10 and 500, between 30 and 500, between 30 and 300, between 30 and 80, or between 200 and 500.

The cross section of the waveguide cavity may be in particular polygonal, for example rectangular or square. The size and/or shape of the cross section of the waveguide cavity perpendicular to the central longitudinal axis may preferably be constant along the central longitudinal axis, i.e. in particular from the waveguide input as far as the waveguide output.

The main body of the hollow waveguide may enclose the waveguide cavity in particular circumferentially, in particular in directions perpendicular to the central longitudinal axis of the hollow waveguide.

The main body of the hollow waveguide may be rigid, in particular. It may be formed in one part or in multiple parts. The main body may be composed of glass and/or metal, for example. The main body may preferably be manufactured from an EUV-reflective material, for example ruthenium and/or molybdenum, and/or may be coated therewith in the region of the cavity inner wall.

The hollow waveguide assembly may comprise in particular a cover which at least partially encloses the hollow waveguide. The cover may serve in particular to stabilize and/or protect the main body. The waveguide purging device may be at least partially integrated into the cover and/or formed between the cover and other components of the hollow waveguide assembly, for example between the cover and an illumination light guide disposed downstream of the hollow waveguide.

For purging, in particular for continuously purging, the waveguide cavity, purge gas is supplied, at least indirectly, to the waveguide output via the purging device. The purge gas may be provided in particular by an external purge gas source that is fluidically connected to the purge gas connector of the purging device.

The purge gas is supplied to the waveguide output, at least indirectly, by use of a nozzle. Indirect supply should be understood here to mean that the purge gas from the nozzle does not directly flow in at the waveguide output or flow into the waveguide cavity. The purge gas may flow in indirectly for example, by virtue of the fact that further flow-effective components may be arranged fluidically between the nozzle and the waveguide output. For example, a pressure and/or a flow rate of the purge gas in the waveguide cavity may be influenced, in particular controlled, by way of further flow-effective components.

The nozzle may be formed in particular as a rotationally symmetrical component part. The nozzle may be in particular a ring nozzle.

An optical hollow waveguide according to Claim 2 is of particular practical relevance. EUV sources may result in contaminations of the hollow waveguide that may be reliably removed by use of the waveguide purging device. The EUV range may correspond in particular to a wavelength range of between 2 nm and 30 nm, for example in the range of between 2.3 nm and 4.4 nm or in the range of between 5 nm and 30 nm, for example at 13.5 nm. The requirements made of optical component parts, in particular for guiding and reflecting the illumination light, are particularly high in this wavelength range.

In particular, an inner wall of the waveguide cavity may be designed to be reflective, in particular highly reflective, for the illumination light, at least under grazing incidence. It is possible here in particular for the inner wall to be coated with a coating, for example composed of ruthenium, that is highly reflective for light in the EUV wavelength range.

An optical hollow waveguide assembly according to Claim 3 enables the pressure and/or the speed of the purge gas in the waveguide cavity to be set particularly precisely.

In the purge gas connector, the purge gas has comparatively high pressures and/or comparatively high speeds. Here and hereinafter, the pressure at which the purge gas is provided via the purge gas connector is also referred to as first pressure. Here and hereinafter, the speed at which the purge gas is provided via the purge gas connector is also referred to as first speed. In this regard, speed should be understood to mean a flow speed of the gas.

A first pressure of the purge gas may be in particular in the range of 20 Pa to 70 Pa, in particular in the range of 25 Pa to 60 Pa, and in particular in the range of 30 Pa to 50 Pa.

A first speed may be in particular in the range of 700 m/s to 1000 m/s, in particular 750 m/s to 950 m/s, and in particular 800 m/s to 900 m/s.

The first pressure and/or the first speed may result in severe eddies in the purge gas and/or mechanical loading, in particular damage, of optical component parts, in particular of the hollow waveguide and the main body thereof.

By use of the reducer, the first pressure and/or the first speed can be deliberately reduced to the second pressure and/or the second speed. The second pressure and/or the second speed are/is of orders of magnitude at which unwanted eddies may be avoided, at least to the greatest possible extent, and at which the purge gas has non-critical kinetic energies.

The second pressure may be in particular in the range of 10 Pa to 30 Pa, in particular 12 Pa to 28 Pa, and in particular in the range of 15 Pa to 25 Pa.

The second speed may be in particular in the range of 10 m/s to 40 m/s, in particular 15 m/s to 35 m/s, and in particular 20 m/s to 30 m/s.

In particular, a third pressure and a third speed of the purge gas may be established in the waveguide cavity.

In this case, the third pressure may be in particular in the range of 8 Pa to 17 Pa, in particular 9 Pa to 16 Pa, and in particular 10 Pa to 15 Pa.

The third speed may be in particular in the range of 3 m/s to 12 m/s, in particular 4 m/s to 11 m/s, and in particular 5 m/s to 10 m/s.

Since the third speed is directed in particular to the waveguide input, the purge gas will propagate, at least substantially, through the waveguide cavity towards the waveguide input.

At the waveguide input, the purge gas may have in particular a fourth pressure and/or a fourth speed.

In this case, the fourth pressure is in particular less than 15 Pa, in particular less than 13 Pa, and in particular less than 10 Pa.

This gives rise to a pressure difference between the second pressure and the fourth pressure. The pressure difference may be in particular in the range of 8 Pa to 17 Pa, in particular 9 Pa to 16 Pa, and in particular 10 Pa to 15 Pa. This pressure difference draws the purge gas further in the direction of the waveguide input.

The fourth speed may be in the range of 2 m/s to 8 m/s, in particular 3 m/s to 7 m/s, and in particular 4 m/s to 6 m/s.

An optical hollow waveguide assembly according to Claim 4 can be realized particularly easily. By use of the pressure chamber, the purge gas can be accumulated in such a way that the second pressure and/or the second speed can be set, in accordance with the Bernoulli equation and/or the continuity equation. The pressure chamber can be realized in a simple manner in terms of production engineering.

The pressure chamber may be disposed directly downstream of the purge gas connector.

It is also possible for the pressure chamber to be disposed indirectly downstream of the purge gas connector. In this case, the purge gas connector may be fluidically connected to the pressure chamber by use of an additional purge gas line, for example.

The pressure chamber may be formed in particular in a ring-shaped fashion around a beam path of the illumination light. This enables the purge gas to be uniformly distributed and adapted in terms of pressure and/or speed even with one-way supply via the purge gas connector.

By use of an optical hollow waveguide assembly according to Claim 5, the second pressure and/or the second speed are/is settable even more accurately.

The intermediate gap may have in particular a cross-sectional area that is smaller than a cross-sectional area of the pressure chamber. A cross-sectional narrowing may be formed upon transition from the pressure chamber to the intermediate gap.

A cross-sectional widening may be formed upon transition from the intermediate gap to the nozzle.

An optical hollow waveguide assembly according to Claim 6 is firstly particularly robust and secondly particularly compact. The use of a cover enables the hollow waveguide to be shielded particularly well against surroundings. Adverse environmental influences on the hollow waveguide can be shielded as a result.

The cover is designed in particular to enclose a lateral surface of the hollow waveguide. The cover may be designed to be fluid-tight in particular at least in the region of the waveguide output. This improves the setting of the dynamic pressures and thus targeted guidance of the purge gas flow. The waveguide input may be formed in particular at a bottom surface of the hollow waveguide. The waveguide output may be formed in particular at a top surface of the hollow waveguide.

It is also possible for the cover to enclose, at least partially, the top surface of the hollow waveguide.

As a result of the, at least partial, integration of the hollow waveguide purging device, the optical hollow waveguide assembly is of particularly efficient design in terms of installation space, on account of the spatial synergies of the cover and the hollow waveguide purging device.

The waveguide purging device may be in particular fully integrated into the cover. The hollow waveguide purging device may form in particular a part of the cover in the region of the waveguide output.

An optical hollow waveguide assembly according to Claim 7 is integratable particularly efficiently into a superordinate optical system, for example an illumination optics unit. By use of the illumination light guide, the illumination light may be deliberately transferred to further components of the illumination optics unit, in particular to an output coupling optics unit.

By use of the illumination light guide, the illumination light may be guided in a manner protected from external influences. It is also possible to deliberately influence a shape and/or a direction of the illumination light, in particular of a wavefront of the illumination light. This may further contribute to an efficient design of the optical hollow waveguide assembly in terms of installation space.

The illumination light guide may comprise in particular a guide base, by which the illumination light guide is arranged, and in particular secured, on the hollow waveguide. A guide input may be arranged on the guide base, the illumination light entering the illumination light guide at said guide input. The guide input may be arranged in particular flush with the waveguide output.

The illumination light guide may comprise in particular a hollow, for example tubular, guide main body, by use of which the shape and/or the direction of the illumination light may be influenced.

The illumination light guide may comprise in particular a guide cover plate, which may be situated opposite the guide base, in relation to the guide main body. A guide output may be formed in the guide cover plate, the illumination light emerging from said guide output.

Guide main body, guide base and/or guide cover plate may be formed in an integral fashion, in particular.

The illumination light guide is designed in particular for guiding illumination light in the EUV range.

An optical hollow waveguide assembly according to Claim 8 is embodied particularly compactly. The, at least partial, integration of the waveguide purging device into the illumination light guide enables installation space to be saved.

The waveguide purging device may be arranged in particular on the guide base. The waveguide purging device may be arranged in particular in a manner integrated, at least partially, into the guide base.

The waveguide purging device may be in particular fully integrated into the illumination light guide, in particular into the guide base. In such a case, the illumination light guide, in particular the guide base, may be integrated, at least partially and in particular fully, into the cover. The illumination light guide may form in particular a part of the cover, in particular a part of the cover in the region of the waveguide output.

By use of an optical hollow waveguide assembly according to Claim 9, the purge gas can be used substantially, and in particular completely, for purging the waveguide cavity. The flow properties, in particular pressure and/or speed, of the purge gas in the waveguide cavity may be deliberately influenced by use of the nozzle.

Since the illumination light, after passing through the waveguide cavity, is transferred to further components of the illumination optics unit, in particular by use of the illumination light guide, the region around the waveguide output cannot be made completely fluid-tight vis-à-vis the surroundings and in particular vis-à-vis the illumination light guide.

In order to avoid diffusion losses of the purge gas to the greatest possible extent, and in particular completely, the purge gas is introduced directly into the waveguide cavity via the waveguide output.

By use of an optical hollow waveguide assembly according to Claim 10, the second pressure and/or the second speed can be established particularly precisely. The purge gas is indirectly supplied to the waveguide output via the accumulation chamber. Adverse effects on the hollow waveguide cavity and/or the hollow waveguide output and/or the beam path of the illumination light as a result of directly introduced purge gas are minimized.

As a result of introducing the purge gas into the accumulation chamber, deliberate turbulence may be induced in the accumulation chamber. The turbulence may be induced in particular in the vicinity of the waveguide output. This may result in an accumulation point, coinciding with the waveguide output, in particular, at which the purge gas has the desired pressure (second pressure) and/or the desired speed (second speed). Since this turbulence may be deliberately controlled, the second pressure and/or the second speed may thus be precisely settable.

The accumulation chamber may be formed in particular between the cover and the hollow waveguide.

The accumulation chamber may be formed in particular between the illumination light guide, in particular the guide base, and the hollow waveguide.

An optical hollow waveguide assembly according to Claim 11 further contributes to optimally using the purge gas.

By use of a plurality of nozzle openings arranged symmetrically with respect to the waveguide output, it is possible, in the case of direct introduction into the waveguide cavity, for speed components extending perpendicular to the central longitudinal axis of the waveguide cavity to be reduced, in particular averaged out. This results in a purge gas which exhibits particularly laminar flow and which may be used substantially, and in particular fully.

Even in the case of introduction into the accumulation chamber, a plurality of nozzle openings prove to be advantageous because it is thereby possible to control the turbulence around the accumulation point with higher accuracy.

By use of an optical hollow waveguide assembly according to Claim 12, the purge gas utilization can be further optimized. The reduced-pressure generator assists the purge gas flow from the waveguide output to the waveguide input. The surroundings of the waveguide input may be evacuated by the reduced-pressure generator. In particular, a vacuum may be generated in the region of the waveguide input.

The reduced-pressure generator may serve for evacuating a superordinate optical system, for example an illumination optics unit.

For example, a vacuum pump may be used as the reduced-pressure generator.

A further problem that can be addressed by the invention is that of improving an illumination optics unit.

This problem can be solved by an illumination optics unit having the features presented in Claim 13.

The illumination optics unit may comprise further optical components and optical systems, such as stops and mirrors, in order to focus the illumination light in an object plane onto an object.

An illumination optics unit according to Claim 14 is of particular practical relevance. The illumination optics unit may be used in particular for illuminating masks for lithography, in particular microlithography or nanolithography. The masks may be illuminated in the context of the lithography process and/or in the context of inspection of the masks.

A further problem that can be addressed by the invention is that of improving an inspection apparatus.

This problem can be solved by an inspection apparatus having the features presented in Claim 15.

The inspection apparatus may also comprise, besides the illumination optics unit, a projection optics unit which focuses the illumination light reflected by the object in the object field, in particular in the EUV range, into an image field in order to create an image of the object there.

The object to be inspected may be in particular a photolithographic mask and/or a photolithographic wafer. The mask and/or the wafer may be structured or unstructured.

### BRIEF DESCRIPTION OF DRAWINGS

An exemplary embodiment of the invention is explained in greater detail below with reference to the drawing, in which:

FIG. 1 schematically shows an optical system having an illumination optics unit for a mask inspection system for use with EUV illumination light;

FIG. 2 shows a schematic view of a sectional illustration of a first exemplary embodiment of a hollow waveguide assembly having a waveguide purging device and an illumination light guide;

FIG. 3 shows a schematic view of a sectional illustration of a further exemplary embodiment of a hollow waveguide assembly having a waveguide purging device and an illumination light guide;

FIG. 4 shows a schematic view of a sectional illustration of a third exemplary embodiment of a hollow waveguide assembly having a waveguide purging device and an illumination light guide;

FIG. 5 shows a perspective view of an exemplary embodiment of an illumination light guide;

FIG. 6 shows a sectional illustration of the illumination light guide according to FIG. 5; and

FIG. 7 shows a schematic view of a guide input of an illumination light guide according to FIG. 5.

### DETAILED DESCRIPTION

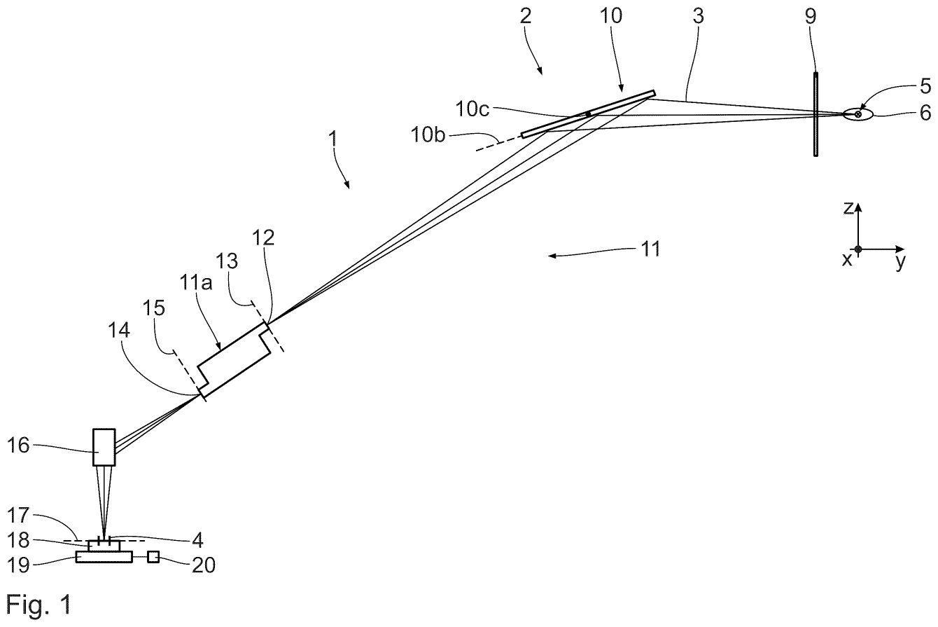

Referring to FIG. 1, an illumination optics unit 1 is a constituent part of an illumination system 2 of a mask inspection system for use with EUV illumination light 3. In the drawing, a beam path of the illumination light 3 is illustrated by way of marginal rays. An illumination field or object field 4 of the mask inspection system is illuminated by the illumination light 3.

The illumination light 3 is created by an EUV light source 5 in a source region or source volume 6. The light source 5 can create EUV used radiation in a wavelength range of between 2 nm and 30 nm, for example in the range of between 2.3 nm and 4.4 nm or in the range of between 5 nm and 30 nm, for example at 13.5 nm.

The light source 5 may be embodied as a plasma light source. For example, it can be a laser plasma source (LPP; laser produced plasma) or else a discharge source (DPP; discharge produced plasma). It is also possible to use a high-harmonic EUV source. In principle, such plasma sources are known light sources for EUV projection exposure apparatuses.

In order to facilitate positional relationships, a Cartesian xyz-coordinate system will be used hereinafter. The x-axis is perpendicular to the drawing plane of FIG. 1. The y-axis runs horizontally to the right in FIG. 1, and the z-axis runs vertically upwards in FIG. 1.

The source region 6 has an approximately ellipsoidal shape and has a greatest extent, which is also referred to as main direction of extent, parallel to the y-axis. A main emission direction of the illumination light 3 from the source region 6 runs along this main direction of extent, i.e.

along a longest major axis of the ellipsoidal source region 6 in the case of an ellipsoidal approximation.

Following its emission by the light source 5, the illumination light 3 initially passes through an aperture stop 9 which delimits the edge of a beam of the illumination light 3.

The aperture stop 9 can be designed to be interchangeable. For example, a stop wheel may be provided to this end, the latter storing various aperture stop embodiments which can be used alternately within the beam path of the illumination light 3. Different input apertures of the illumination light 3 may be specified by way of such an interchangeable aperture stop design.

The aperture stop 9 may be embodied to be interchangeable and/or adjustable, and/or settable in respect of its stop edge. Different stop geometries of the aperture stop 9 can be realized and/or set as a result. For example, specifiable stop geometries might be round with a selectable diameter and/or elliptical with a selectable ellipse size and optionally with a selectable semi-axis ratio of the ellipses. Such a semi-axis ratio of an ellipse specifiable by way of the aperture stop 9 may be 2:1.

Downstream of the aperture stop 9, the illumination light beam 3 is transferred from an input coupling mirror 10 to a beam homogenization device 11 of the illumination optics unit 1. As yet to be explained in detail below, the input coupling mirror 10 may also be part of the beam homogenization device 11. A beam-homogenizing element, for example a hollow waveguide 11a in this case, may be part of the beam homogenization device 11. In other exemplary embodiments, the beam homogenization device 11 may in an alternative to that or in addition also comprise at least one facet mirror serving to divide the EUV illumination light 3 into a plurality of individual beams that are superimposed on one another for the purpose of homogenizing mixing. In this case, the beam homogenization device may also comprise, e.g., two successively arranged facet mirrors.

The aperture stop 9 restricts a numerical aperture of the illumination light beam 3 emitted by the source region 6 to a value of the numerical aperture in the range of between 0.02 and 0.3, for example in the range of between 0.02 and 0.1 or between 0.05 and 0.08. A numerical aperture as specified by the aperture stop 9 of greater than 0.1, i.e. in the range of between 0.1 and 0.3, allows a greater light yield in the illumination light beam path between the source volume 6 and the illumination field 4.

An incoherent illumination setting may be used.

In an alternative to the aperture stop 9 or in addition, an aperture-limiting stop may be arranged between the hollow waveguide 11a and a downstream optical component of the illumination optics unit 1. An arrangement of such a further aperture stop in the beam path of the illumination light 3 downstream of the hollow waveguide 11a between two downstream optical components of the illumination optics unit 1 is also possible.

For example, the input coupling mirror 10 is embodied as an ellipsoid mirror and serves to image the source region 6 of the EUV light source 5 into a waveguide input 12 in an entrance plane 13 of the hollow waveguide 11a. A first focus of the ellipsoid mirror 10 is therefore located in the source region 6 and a second focus of the ellipsoid mirror 10 is located in the waveguide input 12 or in the region of the waveguide input 12. The ellipsoid mirror 10 is used to focus the illumination light beam 3 into the waveguide input 12 in the entrance plane 13 of the hollow waveguide 11a. An entrance-side numerical aperture of the illumination light beam 3 upon entry into the waveguide input 12 may be in the range of between 0.02 and 0.2, for example be of the order of 0.15 or be of the order of 0.05 or 0.1.

In the embodiment of the illumination optics unit 1 according to FIG. 1, the ellipsoid mirror 10 represents a mirror for grazing incidence (GI).

Depending on the embodiment of the input coupling optics unit, the latter has exactly one input coupling mirror, as depicted in FIG. 1 using the example of the input coupling mirror 10, or else a plurality of input coupling mirrors, e.g. two or three input coupling mirrors.

The waveguide input 12 and a waveguide output 14 of the hollow waveguide 11a are square or rectangular in each case, with typical dimensions in the range of between 0.5 mm and 5 mm. An aspect ratio of the waveguide input 12 and of an identically sized waveguide output 14 of the hollow waveguide 11a for the illumination light 3 in an exit plane 15 is between 0.25 and 4, for example between 0.5 and 2. Typical dimensions of the waveguide input 12 and of the waveguide output 14 of the hollow waveguide 11a are 0.75 mm×0.75 mm, 1.0 mm×2.0 mm or 1.5 mm×2.0 mm.

An inner wall of a waveguide cavity of the hollow waveguide 11a is provided with a highly reflective coating for the illumination light 3, for example a ruthenium coating. The waveguide cavity is cuboid, in accordance with the rectangular waveguide input and waveguide output 12, 14. The hollow waveguide 11a has a typical length in the beam direction of the illumination light 3 in the range of between 10 and 500 mm, for example in the range of between 20 mm and 500 mm, between 20 mm and 300 mm, or else between 20 mm and 80 mm.

Angles of incidence of the illumination light 3 on the inner wall of the waveguide cavity of the hollow waveguide 11a are greater than 60°, for example. Illumination light 3 impinges on the inner wall with grazing incidence.

An angle between a longitudinal axis of the hollow waveguide 11a and the chief ray of the illumination light beam 3 incident into the waveguide input 12 may be 0° or may alternatively also differ from 0° and for example be in the range of between 0° and 1.5°, for example between 0.25° and 0.75° and in particular be of the order of 0.5°.

A ratio of the length of the hollow waveguide 11a, i.e. the distance between the entrance plane 13 and the exit plane 15, to a typical diameter of the hollow waveguide 11a, i.e. the typical dimensions or typical diameter of the waveguide input 12 or of the waveguide output 14, is in the range of between 10 and 1000 and may for example be between 10 and 500, between 30 and 500, between 30 and 300, or else between 30 and 80 or between 200 and 500.

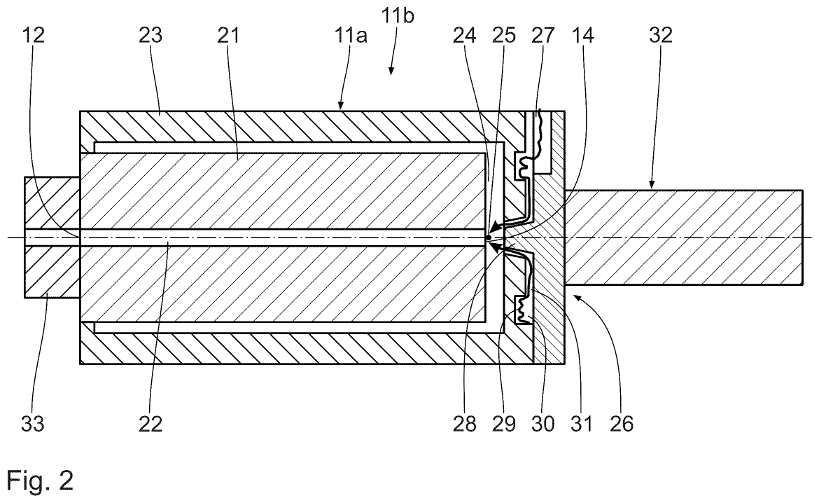

Such a hollow waveguide 11a may be exposed to contaminations as a result of material removal and/or external contaminants. A purge gas device (not depicted in FIG. 1) serves to clean the hollow waveguide 11a and is explained in detail below on the basis of exemplary embodiment variants, with reference being made to FIGS. 2 to 4.

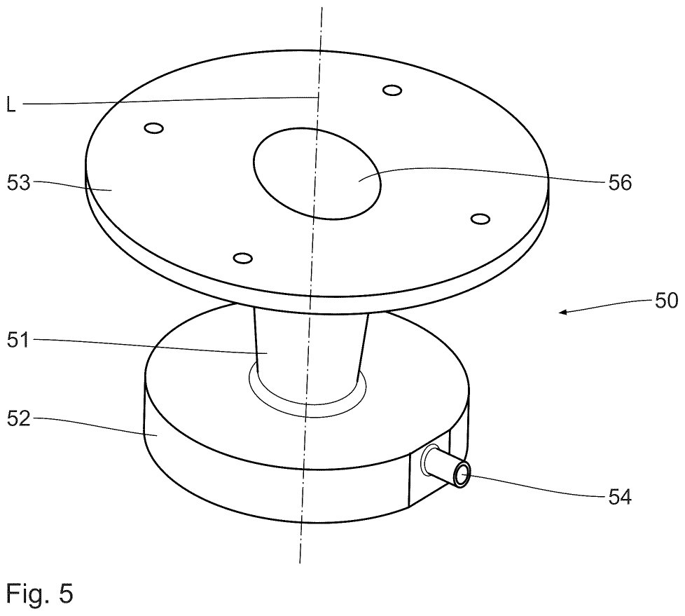

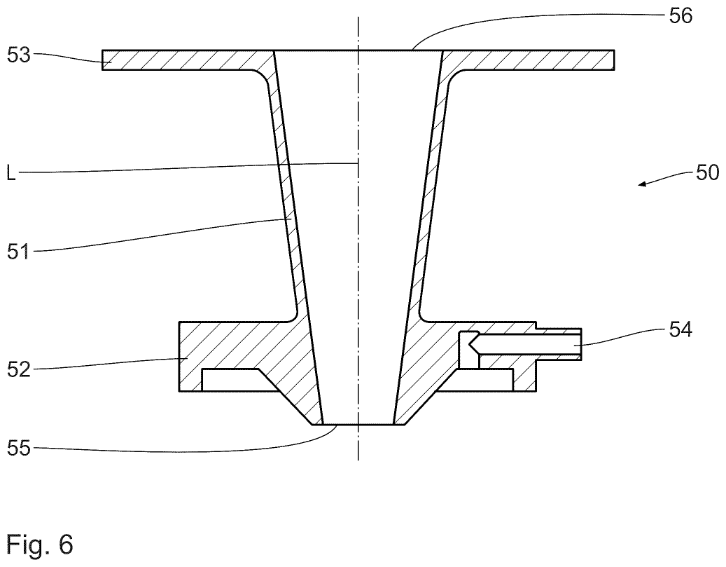

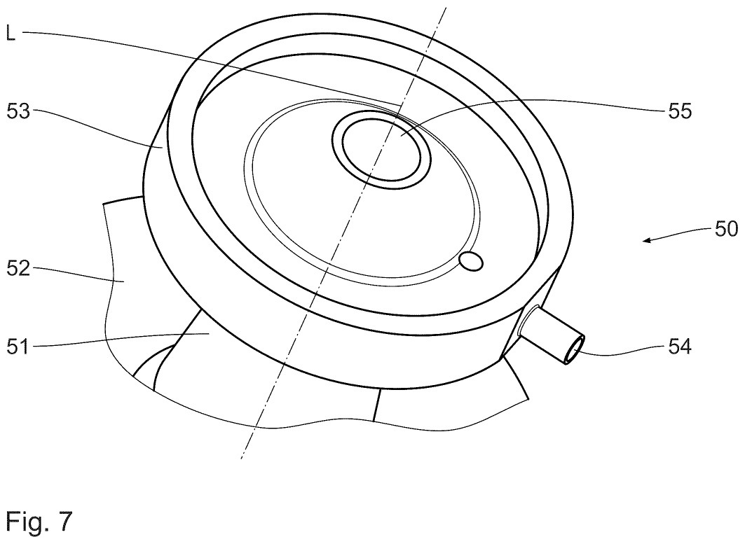

It is possible that the illumination light 3 is transferred to the superordinate optical system by use of an illumination light guide (not depicted in FIG. 1). An exemplary illumination light guide is explained in detail below with reference to FIGS. 5 to 7.

An imaging output-coupling mirror optics unit 16 depicted schematically in FIG. 1 and situated downstream of the hollow waveguide 11a images the waveguide output 14, located in an exit plane 15, of the hollow waveguide 11a into the illumination field 4 in an object plane 17. This imaging may have an image-side numerical aperture in the range of between 0.1 and 0.3.

The e.g. two or more mirrors of the output-coupling mirror optics unit 16 may be embodied as mirrors for grazing incidence of the illumination light 3.

The above-described, optionally used aperture stop downstream of the hollow waveguide 11a may be arranged between the hollow waveguide 11a and a first mirror of the output-coupling mirror optics unit 16 or else between different mirrors of the output-coupling mirror optics unit 16.

The output-coupling mirror optics unit 16 may be embodied in the style of a Wolter telescope, specifically in the style of a Type I Wolter optics unit. Such Wolter optics units are described in J. D. Mangus, J. H. Underwood “Optical Design of a Glancing Incidence X-ray Telescope,” Applied Optics, Vol. 8, 1969, page 95, and the references cited therein. In such Wolter optics units, a hyperboloid may also be used in place of a paraboloid. Such a combination of an ellipsoid mirror with a hyperboloid mirror also constitutes a Type I Wolter optics unit.

A further exemplary embodiment of the output-coupling mirror optics unit 16 is described in U.S. Pat. No. 10,042,248 B2. Alternatively, mirrors of the output-coupling mirror optics unit 16 may also comprise reflection surfaces in the form of free-form surfaces.

A reticle 18 to be inspected, which is held by a reticle holder 19, is arranged in the object plane 17. The reticle holder 19 is mechanically operatively connected to a reticle displacement drive 20, by means of which the reticle 18 is displaced in an object displacement direction y during a mask inspection. In this way, a scanning displacement of the reticle 18 in the object plane 17 is possible.

The illumination field 4 has a typical dimension in the object plane 17 that is less than 1 mm and may be less than 0.5 mm. In the embodiment illustrated, the extent of the illumination field 4 is 0.5 mm in the x-direction and 0.5 mm in the y-direction.

The x/y aspect ratio of the illumination field 4 may correspond to the x/y aspect ratio of the waveguide output 14.

Using a projection optics unit not depicted in FIG. 1, the illumination field 4 is imaged into an image field in an image plane.

The image field is detected by a detection device, for example one charge coupled device (CCD) camera or a plurality of CCD cameras. Regarding details of the imaging into the image field, reference is made to U.S. Pat. No. 10,042,248 B2 and the references specified herein and in U.S. Pat. No. 10,042,248 B2. The entire content of U.S. Pat. No. 10,042,248 is herein incorporated by reference.

An inspection of a structure on the reticle 18, for example, is possible by use of the mask inspection system.

An imaging factor β₁ of the input-coupling mirror optics unit 10 may be in the range of between 0.1 and 50, i.e. its action may vary from a reduction by a factor of 10 to a magnification by a factor of 50. An imaging factor β₂ of the output-coupling mirror optics unit 16 may be in the range of between 0.02 and 10, i.e. its action in turn may vary from a reduction by a factor of 50 to a magnification by a factor 10. In the case of the illumination optics unit 1, a product β₁, β₃ of the two imaging factors may range between 0.25 and 10.

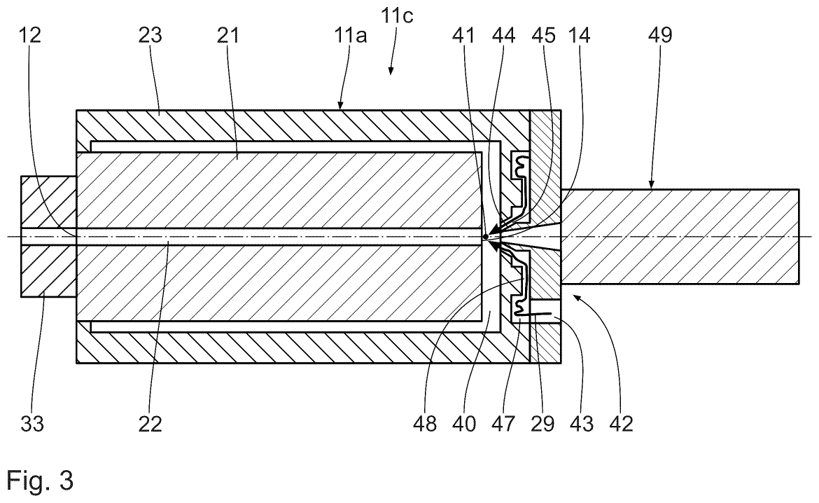

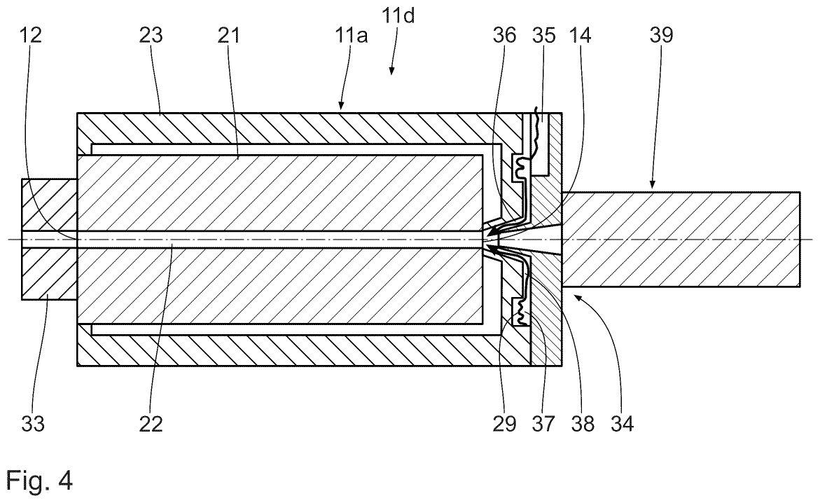

Three exemplary embodiments of an optical hollow waveguide assembly 11b with a hollow waveguide 11a comprising a purge gas device and an illumination light guide are explained in detail below with reference to FIGS. 2 to 4. Initially, an exemplary embodiment is explained in detail on the basis of FIG. 2. Identical components in the exemplary embodiments according to FIGS. 3 and 4, which are explained subsequently, bear identical reference signs and are not described in detail again.

The hollow waveguide 11a has a main body 21. In particular, the main body 21 may be formed from multiple parts. With regard to a possible embodiment of the main body 21 of the hollow waveguide 11a, reference is made to DE 10 2014 219 112 A1, in particular FIG. 3 and the associated description therein, the disclosure of which is fully incorporated by reference in this application.

A waveguide cavity 22 is formed in the interior of the main body 21. In particular, the waveguide cavity 22 has an inner face that is coated with a coating, for example made of ruthenium, that is highly reflective for light in the EUV or DUV range.

The main body 21 is enclosed by a cover 23. The cover 23 primarily serves to protect the main body 21.

The hollow waveguide assembly 11b moreover comprises a waveguide purging device 26 having a purge gas connector 27 and a nozzle 28. The waveguide purging device 26 serves to purge the hollow waveguide 11a, in particular the waveguide cavity 22, with purge gas 29. In particular, the hollow waveguide 11a may be purged continuously with purge gas 29. In particular, hydrogen gas may be used as purge gas 29. The purge gas connector 27 may be connected to a purge gas source, such as a hydrogen gas source, or a purge gas storage, such as a hydrogen gas storage, which produces and/or stores the purge gas. For example, the purge gas connector 27 may be connected to the purge gas source and/or purge gas storage via a purge gas supply line. The purge gas supply line may comprise mechanisms to actively or passively control the flow of purge gas 29 to the purge gas connector 27.

In the exemplary embodiment according to FIG. 2, the cover 23 is attached to the main body 21 in such a way that an accumulation chamber 24 is formed in the region of the waveguide output 14. An accumulation point 25 forms within the accumulation chamber and substantially coincides with the waveguide output 14.

For example, the accumulation chamber 24 may be a free space formed between the end face of the waveguide main body 21 and further components, in particular the cover 23, in the region of the waveguide output 14. For example, the cover 23 may be spaced apparat from the main body 21 along the central longitudinal axis of the hollow waveguide 11a to form the accumulation chamber 24. In direction perpendicular to the central longitudinal axis of the hollow waveguide 11a, the shape of the accumulation chamber 24 may essentially correspond to the cross section of the main body 21 perpendicular to the central longitudinal axis of the hollow waveguide 11a.

The purge gas 29 is initially introduced into a pressure chamber 30 of the waveguide purging device 26 via the purge gas connector 27. The pressure chamber 30 serves to reduce a first pressure P₁ and a first speed V₁, at which the purge gas flows in via the purge gas connector 27. The pressure chamber 30 may be formed in particular in a ring-shaped fashion around a beam path of the illumination light/central longitudinal axis of the hollow waveguide 11a. This enables the purge gas to be uniformly distributed and adapted in terms of pressure and/or speed even with one-way supply via the purge gas connector. The pressure chamber 30 may be disposed directly or indirectly downstream of the purge gas connector 27. In the latter case, the purge gas connector 27 may be fluidically connected to the pressure chamber by use of an additional purge gas line, for example. In some examples, the one or more pressure chambers 30 are parts of or acts as a reducer for reducing a pressure and/or a speed of the supplied purge gas. For example, the reducer may be established by the pressure chamber 30. In other examples. The reducer may comprise the pressure chamber 30 and downstream purge gas lines, such as an intermediate gap formed between the pressure chamber 30 and the nozzle 28.

In particular, the pressure PI may be in the range of 30 Pa to 50 Pa. In particular, the speed V₁ may be in the range of 800 m/s to 900 m/s. An intermediate gap 31, through which the purge gas 29 flows out of the pressure chamber 30 and into the nozzle 28 and is introduced into the accumulation chamber 24 as a result, is arranged between the pressure chamber 30 and the nozzle 28. For example, the intermediate gap 31 can be defined by in particular a cross-sectional area that is smaller than a cross-sectional area of the pressure chamber 30. A cross-sectional narrowing may be formed upon transition from the pressure chamber 30 to the intermediate gap 31. A cross-sectional widening may be formed upon transition from the intermediate gap 31 to the nozzle 28. The intermediate gap 31 may be ring-shaped like the pressure chamber 30. The pressure chamber 30 and/or the intermediate gap 31 may be formed between different components, such as between the cover 31 and a downstream illumination light guide 32. As a result of the eddies arising when the purge gas 29 is introduced, it is possible to deliberately set a second pressure P₂ and a second speed V₂ at the accumulation point 25. In particular, the second pressure P₂ is in the range of 15 Pa to 25 Pa. In particular, the second speed V₂ is in the range of 20 m/s to 30 m/s.

As a result of the pressure P₂ arising at the accumulation point 25, the purge gas 29 flows into the waveguide cavity 22 and leaves the waveguide cavity 22 at the waveguide input 12. When passing through the waveguide cavity 22, the purge gas 29 will experience a loss of pressure ΔP as a result of friction, inertia of the purge gas 29 and an interaction of the purge gas 29 with the illumination light 3. The purge gas 29 has a third speed V₃ and a third pressure P₃ in the waveguide cavity 22. In particular, the third speed V₃ may be in the range of 5 m/s to 10 m/s. In particular, the third pressure P₃ may be in the range of 10 Pa to 15 Pa.

In particular, it is possible for the waveguide input 12 and the waveguide output 14 to be located at different heights in the Earth's gravitational field, which may influence, in particular increase, the loss of pressure ΔP₃. In particular, it is possible for the loss of pressure ΔP₃ to be in the range of 10 Pa to 15 Pa.

A fourth pressure P₄ and/or a fourth speed V₄ are/is established at the waveguide input 12. In particular, the fourth pressure P₄ may be less than 10 Pa. In particular, the fourth speed V₄ is in the range of 4 m/s to 6 m/s.

As a result, it is possible to purge, in particular continuously purge, the hollow waveguide 11a against the flow. In this context, “against the flow” means that a direction of propagation of the purge gas 29 runs antiparallel to a direction of propagation of the illumination light 3.

Sensors 33 are attached to the waveguide input 12. In particular, the sensors 33 are able to detect the pressure P₄ and/or the speed V₄. The sensors 33 may also measure properties of the illumination light 3, for example its intensity and/or energy. It is also possible that the sensors 33 take the form of purge gas sensors 33 in order to detect a flow rate of the purge gas 29. In particular, the waveguide purging device 26 allows the waveguide 11a, in particular its waveguide cavity 22, to be purged without impairing the positioning and/or function of the sensors 33 at the waveguide input 12.

An illumination light guide 32 that serves to transfer the illumination light 3 from the hollow waveguide to the output-coupling mirror optics unit 16 is arranged at the waveguide output 14. An exemplary illumination light guide 32 is explained in detail below with reference to FIGS. 5 to 7.

The nozzle 28 is used to introduce the purge gas 29 into the waveguide output 14 indirectly, via the accumulation chamber 24. In the exemplary embodiment shown, at least parts of the waveguide purging device 26, in particular the pressure chamber 30, the intermediate gap 31 and the nozzle 28, are formed between the cover and a base of the illumination light guide 32 that faces the hollow waveguide 11a and a side of the cover 23 that faces the illumination light guide 32. For example, appropriate structures that form the corresponding parts of the waveguide purging device 26 when the illumination light guide 32 is secured to the cover 23 may be introduced into the cover 23 and the base of the illumination light guide 32.

For example, the nozzle 28 may be formed between the cover 23 and the illumination light guide 32. As a result, the nozzle 28 may be formed as a ring nozzle, for example. It is also possible to form a plurality of nozzles or nozzle openings between the cover 23 and the illumination light guide 32.

In other exemplary embodiments, at least parts of the waveguide purging device 26, in particular a purge gas connector, a pressure chamber, an intermediate gap and/or one or more nozzles, may be fully integrated into the illumination light guide 32, in particular into the base thereof.

As a result of introducing the purge gas 29 into the accumulation chamber 24, turbulence and/or eddies in the purge gas may be deliberately induced in the accumulation chamber. This turbulence and/or these eddies are particularly pronounced at the accumulation point 25. This may increase the dynamic pressure at the accumulation point 25, whereby a purge gas flow through the waveguide cavity 22 may be improved.

FIG. 3 illustrates a further exemplary embodiment of an optical hollow waveguide assembly 11c, in which the purge gas 29 is introduced indirectly into the waveguide cavity 22 by use of an accumulation chamber 40 and an accumulation point 41. A waveguide purging device 42 having a purge gas connector 43 and a nozzle 44, which has a multiplicity of nozzle openings 45, is also depicted. The waveguide purging device 42 comprises a pressure chamber 47 and an intermediate gap 48.

By using more than one nozzle opening 45, it is possible to influence the eddies in the accumulation chamber 40 particularly deliberately. As a result, the second pressure P₂ and/or the second speed V₂ at the accumulation point 41 can be set particularly precisely.

The nozzle 44 may comprise two nozzle openings 45 in particular, at least three nozzle openings 45 in particular and at least four nozzle openings 45 in particular. In particular, the nozzle openings 45 may be arranged symmetrically around the accumulation point 41.

The waveguide purging device 42 is designed as part of the cover 23 or at least partially integrated into the cover 23.

The optical hollow waveguide assembly 11c comprises an illumination light guide 49, which is formed as a separate component part from the waveguide purging device 42. In particular, the illumination light guide 49 may be connected to the waveguide purging device 42 and in particular fastened to the waveguide purging device 42. It is also possible to integrate individual components of the waveguide purging device 42 into the illumination light guide 49 and/or form these between the cover 23 and the illumination light guide 49.

What is depicted in accordance with the exemplary embodiment according to FIG. 4 is an optical hollow waveguide assembly 11d with a waveguide purging device 34 with a purge gas connector 35 and a nozzle 36. In accordance with the exemplary embodiment according to FIG. 4, too, the waveguide purging device 34 comprises a pressure chamber 37 and an intermediate gap 38.

The exemplary embodiment according to FIG. 4 predominantly differs from the above-described exemplary embodiments in that the purge gas 29 is introduced directly into the waveguide cavity 22. It is possible to leave out an accumulation chamber 24 and an associated accumulation point 25. The nozzle 36 is arranged on the circumferential side of a cross section of the waveguide output 14 in such a way that purge gas 29 flows directly onto the waveguide output 14.

FIG. 4 moreover likewise depicts an illumination light guide 39 which is designed as a separate component part from the waveguide purging device 34.

FIGS. 5 to 7 show an exemplary embodiment of an illumination light guide 50. For example, the illumination light guide 50 may be used in the above-described exemplary embodiments, especially in the exemplary embodiment according to FIG. 2.

In this case, the illumination light guide 50 comprises a guide main body 51, a guide base 52 and a guide cover plate 53.

The guide base 52 serves for a connection, in particular a fluid-tight connection, to the hollow waveguide 11a, in particular to the cover 23 thereof. The guide cover plate 53 serves to connect, in particular flange, the illumination light guide 50 to downstream components in the beam path of the illumination light 3.

An above-described waveguide purging device may be integrated, at least partially, into the guide base 52. In the exemplary embodiment shown, the guide base 52 is designed such that fluid channels for forming the purging device are introduced on the side that faces away from the main body 51. Following the fluid-tight connection of the guide base 52 to a cover 23 of the hollow waveguide 11a, fluid channels, for example the pressure chamber 30, are formed between the guide base 52 and the cover. The purge gas connector 54 is integrated into the guide base 52.

In other exemplary embodiments (not depicted in the figures), the waveguide purging device is fully integrated into the guide base 52. In particular, nozzles that allow the purge gas 29 to flow into the waveguide output 14 directly or indirectly are formed in the guide base 52. In particular, it is possible that the guide base 52 acts as a part of the cover 23 of the hollow waveguide. In that case, it is possible in particular to dispense with a separate cover in the region of the waveguide output 14.

In yet further exemplary embodiments, the waveguide purging device may be independent of the illumination light guide 50. For example, the guide base 52 may serve only to mechanically connect the illumination light guide 50 to a cover 23, in which the waveguide purging device is formed, or to a separate waveguide purging device.

By use of the guide base 52, it is possible to attach the illumination light guide 50 to the hollow waveguide 11a in such a way that the guide input 55 is arranged flush with the waveguide output 14. The guide input 55 serves as the entry point for the illumination light 3 that emerges from the waveguide output 14 of the hollow waveguide 11a.

The guide main body 51 has a longitudinal axis L that in particular runs parallel to the direction of propagation of the illumination light 3 and that in particular coincides with the direction of propagation of the illumination light 3.

In that case, the guide input 55 and the guide output 56 are in planes that are orthogonal to the longitudinal axis L and found at the respective ends of the guide main body 51. The guide main body 51 takes the form of a hollow body that surrounds an interior in which the illumination light 3 is guided from the guide input 55 to the guide output 56. The guide input 55 is formed in the guide base 52; the guide output 56 is formed in the guide cover plate 53.

The interior has a cross section that is defined perpendicular to the longitudinal axis L. The cross section has a cross-sectional area and a cross-sectional shape. In this context, the cross-sectional shape should be understood to mean the shape of the contour of the cross section, independently of the circumference and/or the surface area of the cross-sectional area of the interior. In particular, it is possible that different cross-sectional areas the same in terms of surface area have different cross-sectional shapes. Moreover, it is possible that two cross sections with different cross-sectional areas can have the same cross-sectional shape, for example a round or square cross-sectional shape.

In some implementations, the guide input 55 has a different cross-sectional shape to the guide output 56. At the guide input 55 and at the guide output 56, the interior in each case has the same cross-sectional shape as the guide input 55 and the guide output 56, respectively. The cross-sectional shape of the cross section of the interior changes along the longitudinal axis L between the guide input 55 and guide output 56. The cross-sectional shape changes in particular continuously along the longitudinal axis. The cross-sectional shape of the interior may change in particular smoothly, i.e. without edges and/or kinks, along the longitudinal axis L. It is also possible that the cross-sectional shape of the interior changes discontinuously.

In the exemplary embodiment shown, the guide input 55 has a circular cross-sectional shape. The guide output 56 has an elliptical cross-sectional shape.

In other exemplary embodiments (not shown in the figures), the guide input 55 and the guide output 56 may also have a polygonal cross-sectional shape, in particular a rectangular cross-sectional shape. For example, a cross-sectional shape of the guide input 55 may be a regular polygon, in particular a square. The cross-sectional shape of the guide output 56 may be a non-regular polygon, in particular a rectangle. Combinations of round cross-sectional shapes with polygonal cross-sectional shapes are also possible.

Upon emergence from the guide output 56, the illumination light 3 in particular has a cross-sectional shape of the beam cross section that corresponds to the cross-sectional shape of the guide output 56.

In the exemplary embodiment shown in FIGS. 5 to 7, the guide output 56 has a larger cross-sectional area than the guide input 55. The interior of the guide main body 52 and the guide main body 52 take a conical form. The cross section of the interior changes in such a way that a cross-sectional area increases, in particular increases monotonically, along the longitudinal axis L, while, at the same time, the initially circular cross-sectional shape of the interior transitions into a final elliptical cross-sectional shape.

In particular, the cross-sectional shape of the guide input 55 has an input side ratio S₁ that is substantially equal to 1. As a result of an input side ratio S₁ that is substantially equal to 1, the illumination light guide 50 can be attached particularly easily to a hollow waveguide 11a. Manufacture is simplified on account of the symmetry in the region of the guide input 55. The purge gas supply is also improved, in particular particularly uniform.

In particular, the input side ratio S₁ may be defined as the ratio of the length to width of the smallest rectangle that forms an envelope for the cross section of the guide input 55, i.e. in particular of the smallest rectangle whose area completely contains the cross section of the guide input 55. For a circular cross-sectional shape, such an enveloping rectangle takes the form of a square, as a result of which an input side ratio S₁ of 1 arises. A diameter of the guide input 55 with a circular cross-sectional shape may in particular be in the range of 10 mm to 20 mm, in particular be of the order of approximately 15 mm.

In this example, the guide output 56 has an output side ratio S₂ that is not equal to 1. For the guide output 56, the output side ratio S₂ is defined analogously to the input side ratio S₁ of the guide input 55. For an elliptical cross-sectional shape, the output side ratio S₂ corresponds to the quotient of the major axis and the minor axis of the ellipse. In particular, the semimajor axis of the ellipse may have a length in the range of 30 mm to 60 mm, in particular of the order of approximately 45 mm. In particular, the semiminor axis of the ellipse may have a length in the range of 20 mm to 40 mm, in particular of the order of approximately 30 mm. In particular, the following may apply to the output side ratio S₂:1.1<S₂<1.9 and in particular S₂=1.5.

A number of embodiments of the invention have been described. Nevertheless, it will be understood that various modifications can be made without departing from the spirit and scope of the invention. For example, the shapes, geometry, and/or dimensions of various components of the illumination optics unit 1, the illumination system 2, and/or the mask inspection system can be different from those described above.

While some embodiments, examples or aspects described herein include some but not other features included in other embodiments, examples or aspects combinations of features of different embodiments, examples or aspects are meant to be within the scope of the claims, and form different embodiments, as would be understood by those skilled in the art. The embodiments of the present invention that are described in this specification and the optional features and properties respectively mentioned in this regard should also be understood to be disclosed in all combinations with one another. The description of a feature comprised by an embodiment-unless explicitly explained to the contrary—should also not be understood such that the feature is essential or indispensable for the function of the embodiment. Accordingly, other embodiments are within the scope of the following claims.

What is claimed is:

1. An optical hollow waveguide assembly comprising
an optical hollow waveguide for guiding illumination light,
having a main body having a continuous waveguide cavity having a waveguide input and a waveguide output,
wherein a cavity inner wall of the waveguide cavity is designed to be reflective for the illumination light, and
a waveguide purging device, for purging the waveguide cavity with a purge gas, comprising
a purge gas connector, and
at least one nozzle disposed fluidically downstream of the purge gas connector in order to supply the purge gas, at least indirectly, to the waveguide output, in order to generate a purge gas flow from the waveguide output to the waveguide input.

2. The optical hollow waveguide assembly of claim 1, wherein the optical hollow waveguide is configured for guiding illumination light in the extreme ultraviolet (EUV) range.

3. The optical hollow waveguide assembly of claim 1, wherein a reducer for reducing a pressure and/or a speed of the supplied purge gas is arranged between the purge gas connector and the nozzle.

4. The optical hollow waveguide assembly of claim 3, wherein the reducer comprises at least one pressure chamber for the accumulation of purge gas.

5. The optical hollow waveguide assembly of claim 4, wherein at least one pressure chamber is connected to the at least one nozzle via an intermediate gap.

6. The optical hollow waveguide assembly of claim 1, wherein the hollow waveguide assembly comprises a cover for at least partially enclosing the optical hollow waveguide, wherein the hollow waveguide purging device is integrated at least in part into the cover.

7. The optical hollow waveguide assembly of claim 1, comprising an illumination light guide disposed downstream of the waveguide output in a direction of propagation of the illumination light.

8. The optical hollow waveguide assembly of claim 7, wherein the waveguide purging device is integrated, at least partially, into the illumination light guide.

9. The optical hollow waveguide assembly of claim 1, wherein the nozzle introduces the purge gas directly to the waveguide output.

10. The optical hollow waveguide assembly of claim 1, comprising an accumulation chamber arranged in the region of the waveguide output, wherein the at least one nozzle introduces the purge gas into the accumulation chamber.

11. The optical hollow waveguide assembly of claim 1, wherein the waveguide purging device comprises at least two nozzles arranged symmetrically with respect to a central longitudinal axis of the waveguide cavity.

12. The optical hollow waveguide assembly of claim 1, comprising a reduced-pressure generator arranged in the region of the waveguide input.

13. An illumination optics unit having an optical hollow waveguide assembly according to claim 1.

14. The illumination optics unit of claim 13, wherein the illumination optics unit is designed for illumination by use of illumination light in the extreme ultraviolet (EUV) range.

15. An inspection apparatus having an illumination optics unit of claim 13.

16. The inspection apparatus of claim 15, wherein the illumination optics unit is designed for illumination by use of illumination light in the extreme ultraviolet (EUV) range.

17. The inspection apparatus of claim 15, wherein the optical hollow waveguide is configured for guiding illumination light in the extreme ultraviolet (EUV) range.

18. The inspection apparatus of claim 15, wherein a reducer for reducing a pressure and/or a speed of the supplied purge gas is arranged between the purge gas connector and the nozzle.

19. The illumination optics unit of claim 13, wherein the optical hollow waveguide is configured for guiding illumination light in the extreme ultraviolet (EUV) range.

20. The illumination optics unit of claim 13, wherein a reducer for reducing a pressure and/or a speed of the supplied purge gas is arranged between the purge gas connector and the nozzle.
